(19) United States
(12) Patent Application Publication
(10) Pub. No.: US 2025/0308869 A1
(43) Pub. Date: Oct. 2, 2025

(54) PHOTOIONIZATION DETECTOR (PID) LAMP ASSEMBLY AND A METHOD TO MANUFACTURE THE PID LAMP ASSEMBLY

(71) Applicant: LIFE SAFETY DISTRIBUTION GMBH, Rolle (CH)

(72) Inventors: Chuang HUANG, Charlotte, NC (US); Guangli XIE, Charlotte, NC (US); Yuhui XU, Charlotte, NC (US); Qingling WANG, Charlotte, NC (US)

(21) Appl. No.: 19/075,446

(22) Filed: Mar. 10, 2025

(30) Foreign Application Priority Data
Mar. 27, 2024 (CN) 202410364333.6

(51) Int. Cl. H01J 41/02

(52) U.S. Cl. CPC H01J 41/02; H01J 2893/0022; H01J 2893/0035

(57) ABSTRACT

A photoionization detector (PID) lamp assembly and method are disclosed. The PID lamp assembly comprises a cap defining a lamp chamber within and the cap having a step aperture. Further, a crystal window is sealed over the cap and is configured to allow the passing of ultraviolet (UV) light. Further, a capillary tube is sealed to the cap via the step aperture of the cap. Thereafter, a pair of annular grooves are formed on the cap to install a pair of driving pads on the cap.

This application claims priority pursuant to 35 U.S.C. 119(a) to Chinese Application No. 202410364333.6, filed Mar. 27, 2024, which application is incorporated herein by reference in its entirety.

### FIELD

Example embodiments of the present disclosure relate generally to a photoionization detector (PID) lamp, and more particularly related to a PID lamp assembly and a method to manufacture the PID lamp assembly.

### BACKGROUND

Photoionization detector (PID) lamps, such as vacuum ultraviolet (VUV) lamps, are often used in gas detectors. The VUV light may photo-ionize trace organic compounds, but not the air, resulting in electrons being ejected and forming positively charged molecules. The electrons and positive ions are detected by signal collecting and processing circuitry. VUV lamps are often composed of a glass tube with a tail structure extending from the tube. Because the lamp is manufactured with a high temperature, the size of the lamp may be inconsistent and/or the shape of the tail may be inconsistent. Additionally, a pair of driver pads, which turn on the lamp, are conventionally installed in the middle of the tube. As such, conventionally, it may be necessary to elongate the lamp to ensure adequate room for the driver pads. The conventional elongated lamp may result in a PID that is larger than desired. Also, the positioning of the driving pads in the middle of the tube, which is conventional, is not the optimum position, which may result in increased voltage requirements to operate the lamp and PID.

The applicant has identified a number of deficiencies and problems. Through applied effort, ingenuity, and innovation, many of these identified problems have been solved by developing solutions that are included in embodiments of the present disclosure, many examples of which are described in detail herein.

### BRIEF SUMMARY

The following presents a simplified summary to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In an example embodiment, a photoionization detector (PID) lamp assembly is disclosed. The PID lamp assembly comprises a cap defining a lamp chamber within and the cap having a step aperture. Further, a crystal window is sealed over the cap and is configured to allow the passing of ultraviolet (UV) light. Further, a capillary tube is sealed to the cap via the step aperture of the cap. Thereafter, a pair of annular grooves are formed on the cap to install a pair of driving pads on the cap.

In some embodiments, the PID lamp assembly defines height and width. In some embodiments, the height is less than 6 mm and the width is less than 20 mm. In some embodiments, the cap defines a first region and a second region. Further, the first region of the cap is fabricated with a window hole and the second region is fabricated with the pair of annular grooves.

In some embodiments, the window hole is fabricated at the center of the cap and the crystal window is sealed over the window hole of the cap such that the window hole facilitates passing of the UV light through the crystal window. In some embodiments, a radius R1 of the window hole ranges from 2.25 mm to 2.75 mm, and the second region has a radius R2 of 3 mm to 7.5 mm. In some embodiments, the radius R2 is greater than the radius R1.

In some embodiments, a first end of the capillary tube is sealed with the cap via glass powder after insertion of gas within the lamp chamber. In some embodiments, a second end of the capillary tube is connected to a tail tube via a vacuum glue at a low temperature. In some embodiments, the low temperature corresponds to a range of 25° C. to 60° C.

In some embodiments, the step aperture has a first portion and a second portion. Further, the first portion has a diameter that ranges from 0.3 mm to 0.5 mm and the second portion has a diameter that ranges from 0.6 mm to 1 mm. In some embodiments, the step aperture and the pair of annular grooves are formed by drilling. In some embodiments, the drilling corresponds to a cold fabrication process for controlling an overall size of the PID lamp assembly.

In another example embodiment, a method for manufacturing of a PID lamp assembly is disclosed. The method comprises sealing a crystal window over a cap. The cap defined a lamp chamber within. Further, the crystal window is configured to allow the passing of ultraviolet (UV) light. Further, the method comprises sealing a capillary tube to the cap via a step aperture of the cap. Thereafter, the method comprises forming a pair of annular grooves on the cap to install a pair of driving pads on the cap.

The above summary is provided merely for the purpose of summarizing some exemplary embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which are further explained within the following detailed description and accompanying drawings.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1A illustrates a cross-sectional view of a photoionization detector (PID) lamp assembly in accordance with an example embodiment of the present disclosure;

FIG. 1B illustrates a front view of the PID lamp assembly in accordance with an example embodiment of the present disclosure;

FIG. 2 illustrates a side view of a cap of the PID lamp assembly in accordance with an example embodiment of the present disclosure;

FIG. 3 illustrates a side view of the PID lamp assembly before filling the gas in accordance with an example embodiment of the present disclosure; and,

FIG. 4 illustrates a flowchart of a method for manufacturing the PID lamp assembly in accordance with an example embodiment of the present disclosure.

### DETAILED DESCRIPTION

The exemplary embodiments described herein provide detail for illustrative purposes and are subject to many variations in structure and design. It should be appreciated, however, that the embodiments are not limited to a particularly disclosed embodiment shown or described. It is understood that various omissions and substitutions of equivalents are contemplated as circumstances may suggest or render expedient, but these are intended to cover the application or implementation without departing from the spirit or scope of the claims.

Also, it is to be understood that the phraseology and terminology used herein is for the purpose of description and should not be regarded as limiting. The terms “a,” “an,” and “the” herein do not denote a limitation of quantity but rather denote the presence of at least one of the referenced objects. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Like numerals represent like parts in the figures.

Embodiments of the present disclosure will be described more fully hereinafter with reference to the accompanying drawings in which, like numerals, represent like elements throughout the several figures, and in which example embodiments are shown. Embodiments of the present disclosure may, however, be embodied in alternative forms and should not be construed as being limited to the embodiments set forth herein. The examples set forth herein are non-limiting examples and are merely examples among other possible examples.

The present disclosure provides various embodiments of a photoionization detector (PID) lamp assembly and a method to manufacture the photoionization detector (PID) lamp assembly. Embodiments may comprise a cap defining a lamp chamber within and having a step aperture. Embodiments may be configured to seal a crystal window over the cap, to allow passing of ultraviolet (UV) light. Embodiments may be configured to seal a capillary tube to the cap via the step aperture of the cap. Embodiments may be configured to form a pair of annular grooves on the cap to install a pair of driving pads on the cap.

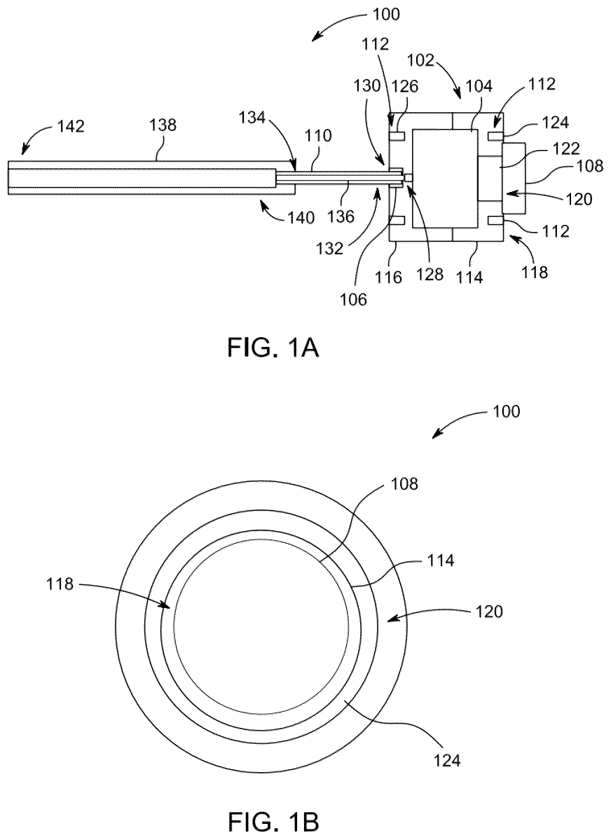

FIG. 1A illustrates a cross-sectional view of a photoionization detector (PID) lamp assembly 100, in accordance with an example embodiment of the present disclosure. FIG. 1B illustrates a front view of the PID lamp assembly 100, in accordance with an example embodiment of the present disclosure.

The PID lamp assembly 100 may comprise a cap 102 defining a lamp chamber 104, a step aperture 106, a crystal window 108, a capillary tube 110, and a pair of annular grooves 112. In some embodiments, the cap 102 may comprise a top cap 114 and a bottom cap 116. Further, the cap 102 may be crafted with a shape such as, but is not limited to, a cylindrical shape, a square shape, or a hexagonal shape. Further, the cap 102 may be crafted with materials such as, but is not limited to, quartz or other transparent materials known in the art.

In some embodiments, the top cap 114 and the bottom cap 116 may be affixed with each other using a glass powder. In some embodiments, the top cap 114 and the bottom cap 116 may be affixed by melting of the glass powder via a heating process. In some embodiments, the heating process may be performed by at least one of a furnace, injection molds, or heating coils. In some embodiments, upon affixing of the top cap 114 with the bottom cap 116, an enclosed structure may be made. Further, the enclosed structure may correspond to the lamp chamber 104. Further, the lamp chamber 104 may be configured to store gas. In various embodiments, the gas may correspond to a krypton gas. In some embodiments, the material of the cap 102 may be selected to prevent absorption of the gas. In some embodiments, the top cap 114 and the bottom cap 116 may be sealed together to form a flat surface of the cap 102.

In various embodiments, the cap 102 is monolithic such that the cap 102 does not include a top cap 114 that is produced separately from a bottom cap 116. For example, a monolithic cap 102 can be manufactured with a casting process or an additive manufacturing process. Even though a top cap 114 and a bottom cap 116 will be referred to herein to describe the cap 102, it should be understood that in the event that the cap 102 is monolithic, the top cap 114 referred to herein is in reference to a top portion of the cap 102 and the bottom cap 116 is in reference to a bottom portion of the cap 102.

In some embodiments, the top cap 114 may comprise a first region 118 and a second region 120. In some embodiments, the first region 118 of the top cap 114 may be fabricated with a window hole 122. The window hole 122 may extend completely through the top cap 114. In some embodiments, a radius R1 of the window hole 122 may range from 2.25 mm to 2.75 mm. In some embodiments, the second region 120 may be fabricated with the pair of annular grooves 112. Further, the second region 120 may have a radius R2 of 3 mm to 7.5 mm. Further, the radius R2 of 3 mm to 7.5 mm may be greater than the radius R1 of 2.25 mm to 2.75 mm. In some embodiments, the window hole 122 may be fabricated at a predefined position on the top cap 114. Further, the predefined position may correspond to a center of the top cap 114. Further, the window hole 122 may be configured to enable sealing of the crystal window 108 with the top cap 114. In some embodiments, the crystal window 108 may be sealed with the window hole 122 using the glass powder. Further, the glass powder may be melted by using the heating process to seal the crystal window 108 with the window hole 122 of the top cap 114.

In some embodiments, the crystal window 108 may be sealed with the top cap 114. Further, the crystal window 108 may be configured to enable translation of an ultraviolet (UV) light from the lamp chamber 104 and towards a target area. Further, the crystal window 108 may be composed of a material that may enable translation of the UV light. In some embodiments, the material of the crystal window 108 may be selected with a view to prevent any absorption or degradation of the UV light translated through the crystal window 108. In some embodiments, the crystal window 108 may have a predefined radius and may be crafted with a shape such as, but is not limited to, a cylindrical shape, or circular shape. In some embodiments the radius of the crystal window 108 may be greater than the radius of the window hole 122.

As illustrated in FIG. 1B, the second region 120 of the top cap 114 may be fabricated with the pair of annular grooves 112. In some embodiments, the pair of annular grooves 112 may be formed by drilling. In some embodiments, the drilling may correspond to, but is not limited to, a cold fabrication process. In some embodiments, the drilling may be configured to control an overall size of the PID lamp assembly 100. In some embodiments, the pair of annular grooves 112 may be formed with a casting process or an additive manufacturing process.

In some embodiments, the pair of annular grooves 112 may be configured to allow installation of a pair of driving pads (not shown) on the cap 102. In some embodiments, the pair of annular grooves 112 may be configured to give a defined space to install the driving pads around a surface of the top cap 114 and the bottom 116. Further, the pair of annular grooves 112 may comprise a first annular groove 124 and a second annular groove 126.

In some embodiments, the first annular groove 124 may be fabricated on the top cap 114 and the second annular groove 126 may be fabricated on the bottom cap 116. Further, the pair of driving pads may comprise a first driving pad (not shown) and a second driving pad (not shown). In some embodiments, the first annular groove 124 may have a diameter D3. Further, the first annular groove 124 may be configured to enable installation of the first driving pad on the top cap 114 of the cap 102. Further, the second annular groove 126 may be configured to enable installation of the second driving pad on the bottom cap 116 of the cap 102. In some embodiments, the driving pads may facilitate stronger electrical strength inside the lamp chamber 104. In one example embodiment, the driving pads may be installed at a front and a back of the lamp chamber 104 to facilitate high electrical field built between the driving pads upon applying high voltage on the driving pads. Such high electrical field may facilitate stimulating the gas filled inside the lamp chamber 104 to generate the UV light.

In some embodiments, the second annular groove 126 may have a diameter D4. Further, the second annular groove 126 may be configured to enable installation of the second driving pad on the bottom cap 116 of the cap 102. In some embodiments, the pair of driving pads may be configured to supply an electric current to the lamp chamber 104. In some embodiments, the pair of driving pads may comprise one or more electronic and electric components. In some embodiments, the pair of driving pads may be connected with a power supply source. In some embodiments, the pair of driving pads may be configured to control intensity of the UV light emitted by the PID assembly 100 by regulating the current supplied to the lamp chamber 104.

In some embodiments, the bottom cap 116 of the cap 102 may have the step aperture 106. In some embodiments, the step aperture 106 may be formed by drilling. In some embodiments, the drilling may correspond to, but is not limited to, the cold fabrication process. In some embodiments, the step aperture 106 may be formed with a casting process or additive manufacturing process. Further, the step aperture 106 may comprise a first portion 128 and a second portion 130. Further, the first portion 128 may have a diameter that may range from 0.3 mm to 0.5 mm. In some embodiments, the second portion 130 may have a diameter that may range from 0.6 mm to 1 mm. Further, in comparison the diameter of the first portion 128 is smaller than the diameter of the second region 130.

In some embodiments, the step aperture 106 of the cap 102 may be configured to enable scaling of the capillary tube 110 with the cap 102 via the glass powder. In some embodiments, the capillary tube 110 may be sealed with the step aperture 106 by melting the glass powder using the heating process. In some embodiments, the capillary tube 110 may be fabricated with a shape such as, but is not limited to, a cylindrical shape. In some embodiments, the capillary tube 110 may comprise a first end 132 and a second end 134. Further, the first end 132 of the capillary tube 110 may be connected with the first portion 128 of the step aperture 106 through the second portion 130 of the step aperture 106. In some embodiments, the capillary tube 110 may comprise an internal cavity 136. In some embodiments, the internal cavity 136 may have a diameter that may be similar to the diameter of the first portion 128 of the step aperture 106.

In some embodiments, the second end 134 of the capillary tube 110 may be connected to a tail tube 138. In some embodiments, the tail tube 138 may comprise a first end 140 and a second end 142. Further, the first end 140 of the tail tube 138 may be connected with the second end 134 of the capillary tube 110 via vacuum glue. In some embodiments, the first end 140 of the tail tube 138 may comprise an inlet (not shown) that may enable connection of the capillary tube 110 with the tail tube 138. In some embodiments, the inlet may have a diameter D5 that may be greater than the diameter of the capillary tube 110. In some embodiments, the tail tube 138 may be connected with the capillary tube 110 by melting the vacuum glue by the heating process at a low temperature. In some embodiments, the low temperature may correspond to a range of 25° C. to 60° C.

In some embodiments, the second end 142 of the tail tube 138 may be configured to enable connection of the tail tube 138 with a gas filling unit (not shown). In some embodiments, the gas filling unit may be configured to supply the gas into the lamp chamber 104 through the capillary tube 110 and the tail tube 138. In some embodiments, the gas filling unit may comprise a gas source, a pressure valve, and an injection unit. In some embodiments, the gas source may be configured to store the gas. In some embodiments, the gas source may correspond to at least one of a gas cylinder, a gas reservoir or like. In some embodiments, the pressure valve may be configured to control pressure of the gas supplied from the gas source to the lamp chamber 104. In some embodiments, the injection unit may be configured to inject the gas into the tail tube 138. Further, the injection unit may correspond to at least one of at least one valve, at least one nozzle or the like.

In some embodiments, the first end 132 of capillary tube 110 may be sealed with the cap 102 after insertion of the gas within the lamp chamber 104. In some embodiments, the first end 132 of the capillary tube 110 may be sealed with the cap 102 by melting glass powder using the heating process. In some embodiments, the PID lamp assembly 100 may define a height and a width. The height is less than 6 mm and the width is less than 20 mm. It will be apparent to one skilled in the art that above-mentioned components of the PID lamp assembly 100 have been provided only for illustration purposes, without departing from the scope of the disclosure.

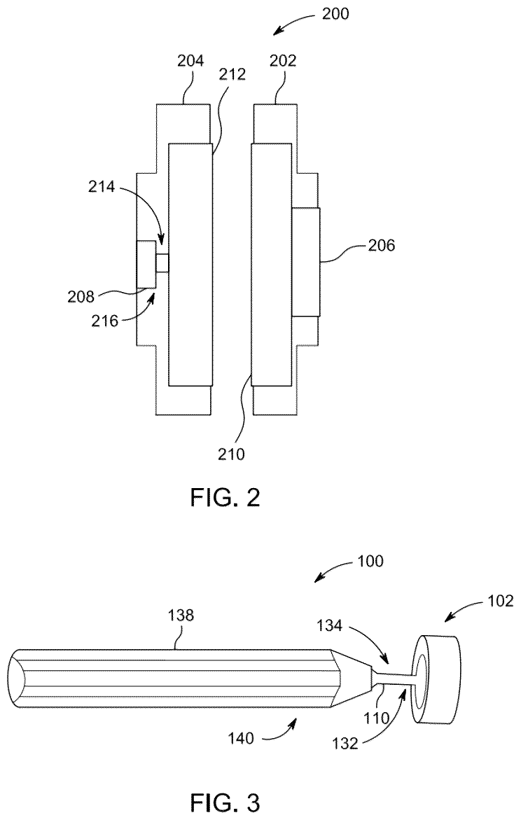

FIG. 2 illustrates a side view of a cap 200, in accordance with an example embodiment of the present disclosure.

In some embodiments, the cap 200 may comprise a top cap 202, a bottom cap 204, a window hole 206, and a step aperture 208. In some embodiments, the cap 200 may be crafted with a shape such as, but is not limited to, a cylindrical shape. Further, the top cap 202 of the cap 200 may be connected with the bottom cap 204 using glass powder. Further, the top cap 202 of the cap 200 and the bottom cap 204 of the cap 200 may be connected by melting the glass powder using a heating process. In some embodiments, the top cap 202 of the cap 200 may be fabricated with a first cavity 210 and the bottom cap 204 of the cap 200 may be fabricated with a second cavity 212. In some embodiments, the first cavity 210 may have a diameter D of 10 mm, and a depth d of 1 mm. In some embodiments, the second cavity 212 may have a diameter D of 10 mm, and a depth d of 1.5 mm. In some embodiments, upon connection of the top cap 202 with the bottom cap 204, the lamp chamber 104 may be formed. In some embodiments, the lamp chamber 104 may be configured to store gas.

In some embodiments, the top cap 202 may be crafted with the window hole 206 that may enable sealing of a crystal window (not shown) with the cap 102. In some embodiments, the window hole 206 may have a diameter D of 5 mm, and a depth d of 1 mm. In some embodiments, the step aperture 208 may be configured to enable filling of the gas inside the cap 102. In some embodiments, the step aperture 208 may comprise a first portion 214 and a second portion 216. In some embodiments, the first portion 214 may have a diameter D1 of 0.3 mm, and a depth d1 of 0.5 mm. In some embodiments, the second portion 216 may have a diameter D2 of 0.6 mm, and a depth d2 of 1 mm. In some embodiments, the first portion 214 may have a diameter smaller than the diameter of the second portion 216.

FIG. 3 illustrates a side view of the PID lamp assembly 100 before filling the gas, in accordance with the example embodiment of the present disclosure.

In some embodiments, the PID lamp assembly 100 may comprise the cap 102, the capillary tube 110, and the tail tube 138. In some embodiments, the cap 102 of the PID lamp assembly 100 may define a height and a width (e.g., a diameter when the cap 102 is cylindrical). Further, the height defined by the cap 102 of the PID lamp assembly 100 may be less than 6 mm. Further, the width defined by the cap 102 of the PID lamp assembly 100 may be less than 20 mm. In some embodiments, the lamp chamber 104 may be filled with gas through the tail tube and the capillary tube 110. In some embodiments, the PID lamp assembly 100 may be configured to emit the UV light upon receiving the electric current from the power source through the pair of driving pads upon receiving the gas. In some embodiments, the tail tube 138 and/or the capillary tube 110 may be removed from the cap 102 after the lamp chamber 104 of the cap 102 is filled with the gas. In some embodiments, a tiny portion of the capillary tube 110 may be left with the lamp chamber 104.

In some embodiments, the cap 102 may be installed with the pair of driving pads via the pair of annular grooves 112. Further, the pair of driving pads may be configured to supply the electric current to the lamp chamber. In some embodiments, the lamp chamber 104 may be configured to store the gas having one or more gas molecules. In some embodiments, upon filling the gas inside the lamp chamber 104, the lamp chamber 104 may be sealed from the capillary tube 110. In some embodiments, to seal the lamp chamber 104, the first end 132 of the capillary tube 110 may be melted and sealed. Further, the one or more gas molecules of the gas may be configured to get ionized due to one or more electrons of the electric current supplied from the power source. In some embodiments, the one or more molecules upon getting ionized generates a UV radiation of a predefined intensity. The UV radiation generated by the ionized molecules may be configured to project the UV light from the cap 102 via the crystal window 108.

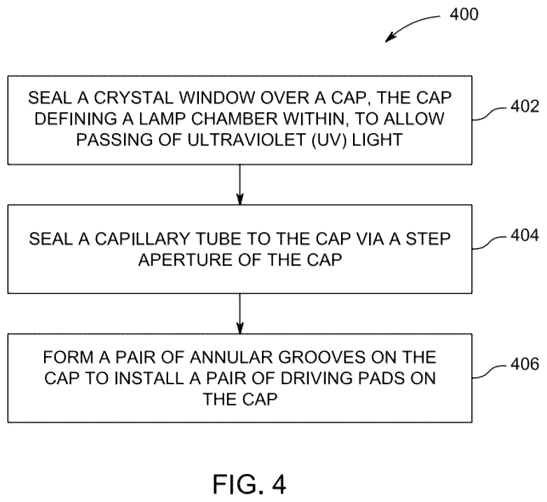

FIG. 4 illustrates a flowchart of a method 400 for manufacturing the PID lamp assembly 100, in accordance with an example embodiment of the present disclosure. FIG. 4 is described in conjunction with FIGS. 1-3.

At an operation 402, the crystal window 108 may be scaled over the cap 102. Further, the cap 102 may define a lamp chamber. Further, the crystal window 108 may be configured to allow passing of the UV light. In some embodiments, the cap 102 may comprise the top cap 114 and the bottom cap 116. Further, the top cap 114 may be drilled with the window hole 122. Further, the crystal window 108 may be sealed with the window hole 122 by melting the glass power between the top cap 114 and the bottom cap 116.

At an operation 404, the capillary tube 110 may be sealed to the cap 102 by the step aperture 106 of the cap 102. Further, the step aperture 106 may comprise the first portion 128 and the second portion 130. In some embodiments, the capillary tube 110 may comprise the first end 132 and the second end 134. Further, the first end 132 of the capillary tube 110 may be sealed with the first portion 128 of the step aperture 106 by melting the glass powder. In some embodiments, the capillary tube 110 may be configured to enable filling of the gas inside the lamp chamber 104.

At an operation 406, the pair of annular grooves 112 may be formed on the cap 102 to install the pair of driving pads on the cap 102. In some embodiments, the pair of annular grooves 112 may comprise the first annular groove 124 and the second annular groove 126. In some embodiments, the first annular groove 124 may be formed on the top cap 114 of the cap 102 and the second annular groove 126 may be formed on the bottom cap 116 of the cap 102. Further, the pair of driving pads may be configured to supply the electric current to the lamp chamber 104 to ionize the gas. In some embodiments, the gas ionized by the pair of driving pads may be configured to generate the UV light that may be further passed through the crystal window 108.

The present disclosure may provide various embodiments of the photoionization detector (PID) lamp assembly 100 and the method to manufacture the photoionization detector (PID) lamp assembly 100. Embodiments may be configured to reduce size of the PID lamp assembly 100. Embodiments may be configured to increase the PID lamp driving cap 102 ability through the reduced size of the crystal window 108. Embodiments may be configured to ensure proper filling of the gas inside the cap 102 through the capillary tube 110 and the tail tube 138. Embodiments may ensure sealing of the gas inside the cap 102 by sealing the capillary tube 110 with the cap 102.

As will be appreciated by one skilled in the art, aspects of the present disclosure may be embodied as a system, method, or computer program product. Accordingly, aspects of various embodiments may take the form of an entirely hardware embodiment, an entirely software embodiment (including firmware, resident software, micro-code, etc.) or an embodiment combining software and hardware aspects that may all generally be referred to herein as a “circuit,” “module”, “system” or “sub-system.” In addition, aspects of the present disclosure may take the form of a computer program product embodied in one or more computer readable medium(s) having computer readable program code embodied thereon.

The foregoing descriptions of specific embodiments have been presented for purposes of illustration and description. They are not intended to be exhaustive or to limit the embodiments to the precise forms disclosed, and obviously many modifications and variations are possible in light of the above teaching. The embodiments were chosen and described to best explain principles and practical applications thereof, and to thereby enable others skilled in the art to best utilize the various embodiments with various modifications as are suited to the particular use contemplated. It is understood that various omissions and substitutions of equivalents are contemplated as circumstances may suggest or render expedient, but these are intended to cover the application or implementation without departing from the spirit or scope of the claims. The following claims are in no way intended to limit the scope of embodiments to the specific embodiments described herein.

What is claimed is:

1. A photoionization detector (PID) lamp assembly, comprising:
a cap defining a lamp chamber within, the cap having a step aperture;
a crystal window sealed over the cap, wherein the crystal window is configured to allow passing of ultraviolet (UV) light; and,
a capillary tube sealed to the cap via the step aperture of the cap,
wherein a pair of annular grooves are formed on the cap to install a pair of driving pads on the cap.

2. The PID lamp assembly of claim 1, wherein the PID lamp assembly defines a height and a width, wherein the height is less than 6 mm and the width is less than 20 mm.

3. The PID lamp assembly of claim 1, wherein the cap defines a first region and a second region, wherein the first region of the cap is fabricated with a window hole and the second region is fabricated with the pair of annular grooves.

4. The PID lamp assembly of claim 3, wherein the window hole is fabricated at a center of the cap and the crystal window is sealed over the window hole of the cap such that the window hole facilitates passing of the UV light through the crystal window.

5. The PID lamp assembly of claim 3, wherein a radius R1 of the window hole ranges from 2.25 mm to 2.75 mm, and the second region has a radius R2 of 3 mm to 7.5 mm, and wherein the radius R2 is greater than the radius R1.

6. The PID lamp assembly of claim 1, wherein a first end of the capillary tube is sealed with the cap via glass powder after insertion of gas within the lamp chamber.

7. The PID lamp assembly of claim 1, wherein a second end of the capillary tube is connected to a tail tube via a vacuum glue at a low temperature.

8. The PID lamp assembly of claim 7, wherein the low temperature corresponds to a range of 25° C. to 60° C.

9. The PID lamp assembly of claim 1, wherein the step aperture has a first portion and a second portion, and wherein the first portion has a diameter that ranges from 0.3 mm to 0.5 mm and the second portion has a diameter that ranges from 0.6 mm to 1 mm.

10. The PID lamp assembly of claim 1, wherein the step aperture and the pair of annular grooves are formed by drilling, and wherein the drilling corresponds to a cold fabrication process for controlling an overall size of the PID lamp assembly.

11. A photoionization detector (PID) lamp assembly, comprising:
a cap defining a lamp chamber within; and,
a crystal window sealed over the cap, wherein the crystal window is configured to allow passing of ultraviolet (UV) light,
wherein a pair of annular grooves are formed on the cap to install a pair of driving pads on the cap.

12. A method for manufacturing of a Photoionization Detector (PID) lamp assembly, the method comprising:
sealing a crystal window over a cap, wherein the cap defining a lamp chamber within, and wherein the crystal window is configured to allow passing of ultraviolet (UV) light;
sealing a capillary tube to the cap via a step aperture of the cap; and,
forming a pair of annular grooves on the cap to install a pair of driving pads on the cap.

13. The method of claim 12, wherein the PID lamp assembly defines a height and a width, wherein the height is less than 6 mm and the width is less than 20 mm.

14. The method of claim 12, wherein the cap defines a first region and a second region, wherein the first region of the cap is fabricated with a window hole and the second region is fabricated with the annular groove.

15. The method of claim 14, wherein the window hole is fabricated at a center of the cap and the crystal window is sealed over the window hole of the cap such that the window hole facilitates passing of the UV light through the crystal window.

16. The method of claim 14, wherein a radius R1 of the window hole ranges from 2.25 mm to 2.75 mm, and the second region has a radius R2 of 3 mm to 7.5 mm, and wherein the radius R2 is greater than the radius R1.

17. The method of claim 12, wherein a first end of the capillary tube is sealed with the cap via glass powder after insertion of gas within the lamp chamber.

18. The method of claim 12, wherein a second end of the capillary tube is connected to a tail tube via a vacuum glue at a low temperature that is less than 60° C.

19. The method of claim 12, wherein the step aperture has a first portion and a second portion, and wherein the first portion has a diameter that ranges from 0.3 mm to 0.5 mm and the second portion has a diameter that ranges from 0.6 mm to 1 mm.

20. The method of claim 12, wherein the step aperture and the pair of annular grooves are formed by drilling, and wherein the drilling corresponds to a cold fabrication process for controlling an overall size of the PID lamp assembly.
